(19) United States
(12) Patent Application Publication
(10) Pub. No.: US 2015/0339737 A1
(43) Pub. Date: Nov. 26, 2015

(54) COMPUTER PROGRAM, METHOD, AND SYSTEM FOR INTERACTIVE FUNDRAISING

(71) Applicant: Complete the Picture LLC, Lawrence, KS (US)

(72) Inventor: Thomas Butt, Lawrence, KS (US)

(21) Appl. No.: 14/717,364

(22) Filed: May 20, 2015

Related U.S. Application Data
(60) Provisional application No. 62/001,435, filed on May 21, 2014.

(51) Int. Cl. G06Q 30/02

(52) U.S. Cl. CPC G06Q 30/0279

(57) ABSTRACT

A computer program, method, and system for facilitating fundraising. The method comprises the initial step of receiving a digital image. An additional step includes receiving fundraising data, with the fundraising data comprising a total amount of funds to be raised for a fundraising campaign. An additional step includes partitioning the digital image into a plurality of tiles, with a number of tiles in the plurality being based on the fundraising data. A further step includes presenting on a graphic display the partitioned digital image.

### RELATED APPLICATIONS

This non-provisional patent application claims priority benefit, with regard to all common subject matter, of earlier-filed U.S. Provisional Patent Application No. 621001,435, filed May 21, 2014, and entitled “COMPUTER PROGRAM, METHOD, AND SYSTEM FOR INTERACTIVE FUNDRAISING.” The identified earlier-filed provisional patent application is hereby incorporated by reference in its entirety into the present non-provisional patent application.

### FIELD

Embodiments of the present invention provide a computer program, method, and system for interactive fundraising. In more detail, embodiments of the present invention are directed to a computer program, method, and system for providing interactive fundraising, which allows donees to create and manage fundraising campaigns and which allows donors to make donations to such fundraising campaigns.

### BACKGROUND

Currently-used processes for fundraising campaigns (e.g., charitable fundraisers) generally involve a donee making a request to receive donations from potential donors. For example, for online donations, a donee may have a website through which the donee can request to receive donations. If a potential donor sees the request and wishes to donate, the donor can make such a donation through a standard electronic check-out application, such as an electronic “shopping-cart” or “check-out” feature. However, such simplistic request and payment processes provide little interaction for the donor. As such, the donor often feels disconnected from the fundraising campaign.

Thus, there is a need for a computer program, method, and system that facilitates interactive fundraising. As a donor becomes interactively engaged in the fundraising process, the donor will not only be more likely to donate, but the donor will also be more likely to donate higher monetary amounts. Furthermore, interactive fundraising may also facilitate the ability to draw additional donors to the fundraising campaign so as to increase the overall amount of donations received.

### SUMMARY

Embodiments of the present invention include computer programs, methods, and systems for facilitating interactive fundraising. In more detail, one of the methods of the present invention comprises the initial step of receiving a digital image. An additional step includes receiving fundraising data, with the fundraising data comprising a total amount of funds to be raised for a fundraising campaign. An additional step includes partitioning the digital image into a plurality of tiles, with a number of tiles in the plurality being based on the fundraising data. A further step includes presenting on a graphic display the partitioned digital image.

Embodiments of the present additionally include a system for facilitating interactive fundraising. The system comprises a processor, a database, and a non-transitory computer readable storage medium with a computer program stored thereon, with the computer program configured to instruct the processor to perform a plurality of steps. An initial step includes receiving a digital image and storing the digital image on a database. An additional step includes receiving fundraising data and storing the fundraising data on the database, with the fundraising data comprising a total amount of funds to be raised. An additional step includes partitioning the digital image into a plurality of tiles, with a number of tiles in the plurality being based on the fundraising data. A next step includes receiving a request from a third-party application to provide access to the partitioned digital image. A next step includes providing the independent application with access to the partitioned digital image, with each of the tiles in the partitioned digital image being obscured. A next step includes receiving, from the third-party application, information indicative of a donation being made. A further step includes providing the independent application with access to the partitioned digital image, with one or more tiles in the partitioned digital image being unobscured.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic depiction of a system for facilitating interactive fundraising in accordance with embodiments of the present invention;

FIG. 2 is a depiction of an exemplary digital image for use in interactive fundraising according to embodiments of the present invention;

FIG. 3 is a depiction of the digital image from FIG. 2, with the digital image partitioned into a plurality of tiles according to embodiments of the present invention;

FIG. 4 is depiction of the partitioned digital image from FIG, 3, with the partitioned digital image having a portion of the tiles at least partially obscured;

FIG. 5 is depiction of the partitioned digital image from FIG. 3, with the partitioned digital image including memorial information in one of the tiles;

FIG. 6 is a flow chart of a method of facilitating interactive fundraising according to embodiments of the present invention; and

FIG. 7 is a flow chart of an additional method of facilitating interactive fundraising according to embodiments of the present invention.

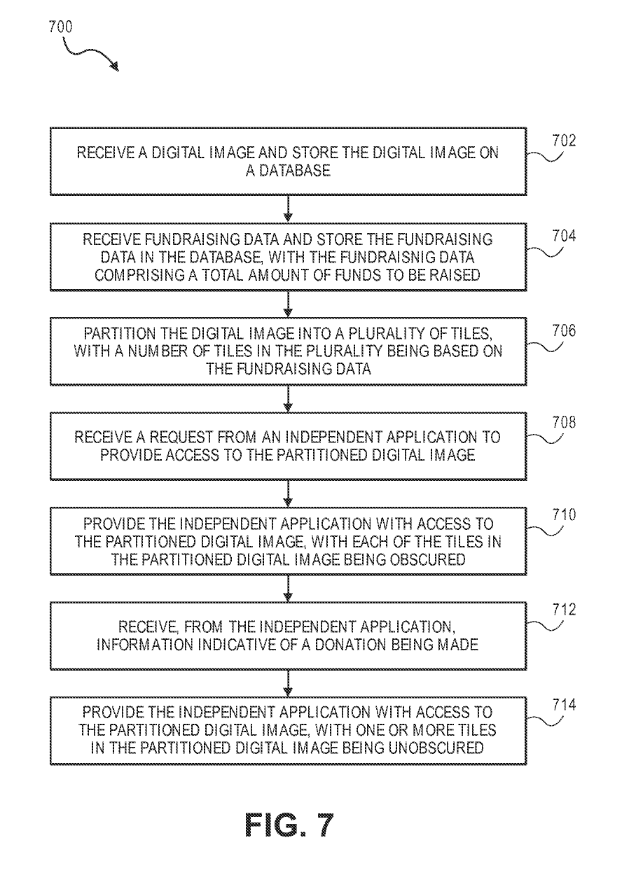

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The present invention provides various embodiments of a computer program, a method, and a system for interactive fundraising. As used throughout, the term “donee” refers to an entity that uses embodiments of the present invention to request and receive donations (e.g., charitable monetary donations). Such donees may include for-profit corporate entities, not-for-profit corporate entities, individuals, or the like. Alternatively, the term “donor” refers to an entity that uses embodiments of the present invention to make donations (e.g., charitable monetary donations). Such donors may include corporate entities, individuals, or the like. As an illustrative example, a donee may be a church that is raising funds to build a new worship center. As such, the church the donee) may use embodiments of the present invention to request and obtain donations from donors, who may be individuals (e.g., parishioners), corporate entities, or the like.

### System

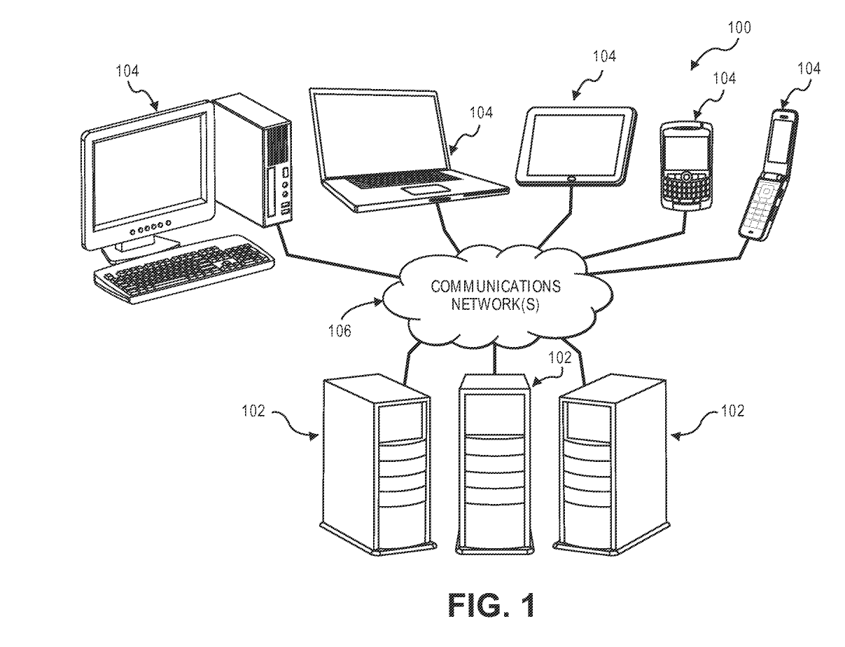

The computer program, system, and method of embodiments of the present invention may be implemented via hardware, software, firmware, or combinations thereof using the interactive fundraising system 100, shown in FIG. 1, which broadly comprises server devices 102, computing devices 104, and a communications network 106. The server devices 102 may include computing devices that provide access to one or more general computing resources, such as Internet services, data transfer services, data storage services, and the like. The server devices 102 may also provide access to a database that stores information related to the interactive fundraising system of embodiments of the present invention. The database may also store other information and data necessary for the implementation of the computer program and method of embodiments of the present invention.

The server devices 102 and computing devices 104 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray and the like, or combinations thereof. In addition to these memory elements, the server devices 102 may further include file stores comprising a plurality of hard disk drives, network attached storage, or a separate storage network.

The computing devices 104 may specifically include mobile communication devices (including wireless devices), work stations, desktop computers, laptop computers, palmtop computers, tablet computers, portable digital assistants (PDA), smart phones, and the like, or combinations thereof. In preferred embodiments, the computing device 104 will have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which discussed in more detail below. In additional embodiments, the computing device 104 may include an optical device such as a digital camera, video camera, optical scanner, or the like, such that the computing device can capture, store, and transmit digital images and/or videos.

The computing devices 104 may include a user control interface that enables one or more users to share information and commands with the computing devices 104 or server devices 102. The user control interface may comprise one or more functionable inputs such as buttons, keyboard, switches, scrolls wheels, voice recognition elements such as a microphone, pointing devices such as mice, touchpads, tracking balls, styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing device 104.

The communications network 106 may be wired or wireless and may include servers, routers, switches, wireless receivers and transmitters, and the like, as well as electrically conductive cables or optical cables. The communications network 106 may also include local, metro, or wide area networks, as well as the Internet, or other cloud networks. Furthermore, the communications network 106 may include cellular or mobile phone networks, as well as landline phone networks, public switched telephone networks, fiber optic networks, or the like.

Both the server devices 102 and the computing devices 104 may be connected to the communications network 106. Server devices 102 may be able to communicate with other server devices 102 or computing devices 104 through the communications network 106. Likewise, computing devices 104 may be able to communicate with other computing devices 104 or server devices 102 through the communications network 106. The connection to the communications network 106 may be wired or wireless. Thus, the server devices 102 and the computing devices 104 may include the appropriate components to establish a wired or a wireless connection.

The computer program of the present invention may run on computing devices 104 or, alternatively, may run on one or more server devices 102. Thus, a first portion of the program, code, or instructions may execute on a first server device 102 or a first computing device 104, while a second portion of the program, code, or instructions may execute on a second server device 102 or a second computing device 104. In some embodiments, other portions of the program, code, or instructions may execute on other server devices 102 or computing devices 104 as well. For example, information related to the interactive fundraising system may be stored on a memory element associated with the server device 102, such that the information is remotely accessible to users of the computer program via one or more computing devices 104. Alternatively, the information may be directly stored on the memory element associated with the one or more computing devices 104 of the user. In additional embodiments of the present invention, a portion of the information may be stored on the server device 102, while another portion may be stored on the one or more computing devices 104. The various actions and calculations described herein as being performed by or using the computer program may actually be performed by one or more computers, processors, or other computational devices, such as the computing devices 104 and/or server devices 102, independently or cooperatively executing portions of the computer program.

In certain embodiments of the present invention, the computer program may be embodied in a stand-alone program downloaded on a user's computing device 104 or in a web-accessible program that is accessible by the user's computing device 104 via the network 106. For the stand-alone program, a downloadable version of the computer program may be stored, at least in part, on the server device 102. A user can download at least a portion of the computer program onto the computing device 104 via the network 106. In such embodiments of the present invention, the computer program may be an “application,” such as an “app” for a mobile device. After the computer program has been downloaded, the program can be installed on the computing device 104 in an executable format. The executable form of the program permits the user to access embodiments of the present invention via an electronic resource, such as a mobile “app” or website. For the web-accessible computer program, the user may simply access the computer program via the network 106 (e.g., the Internet) with the computing device 104. As such, the stand-alone computer program or web-accessible program provides users with access to an electronic resource from which the users can interact with various embodiments of the present invention.

### Operation

Certain embodiments of the present invention may provide users with different types of accounts. Each type of user account may provide their respective users with unique roles, capabilities, and permissions with respect to implementing embodiments of the present invention. For instance, a donee may be provided with a donee account that permits the donee to access embodiments of the present invention for purposes of requesting and/or accepting donations for one or more fundraising campaigns. Additionally, a donor may be provided with a donor account that permits the donor to access embodiments of the present invention for purposes of providing donations and related information for one or more fundraising campaigns. In addition, embodiments of the present invention may include any number and/or any specific types of accounts as may be necessary to carry out the functions, features, and/or implementations of the present invention. For example, some embodiments may provide for an administrator account (“admin account”) that is used by an administrator user (“admin user”) to manage various portions of the execution and maintenance of embodiments of the present invention.

Upon a donee and/or a donor accessing the electronic resource for a first time, the donee and/or a donor may be required to provide certain types of identification information to create their respective accounts. Such identification information may include, for instance, personal name, business name, organization name, physical address, email address, telephone number, or the like. Upon providing the identification information, the donee and/or a donor may be required to enter (or may be given) a username and password, which will be required to access the electronic resource via their account. Although the above-provided description illustrates how a donor may obtain a donor account before making a donation, in some embodiments, the donor will not be required to create an account before making a donation.

### Creating a Fundraising Campaign

Embodiments of the present invention provide an intuitive, user-friendly computer program, method, and system for a donee to create a fundraising campaign to which donors can make donations. Upon accessing the electronic resource of embodiments of the present invention, the donee may be taken to a welcome screen, which provides information and instruction for creating a donee account. From the welcome screen, the donee can either create or access the donee's donee account. If the donee is creating an account, the donee will be taken to an account creation page, where the donee can create an account, as was previously described. If the donee has already created a donee account, the donee may, instead, be required to enter the donee's username and password to access the donee's account.

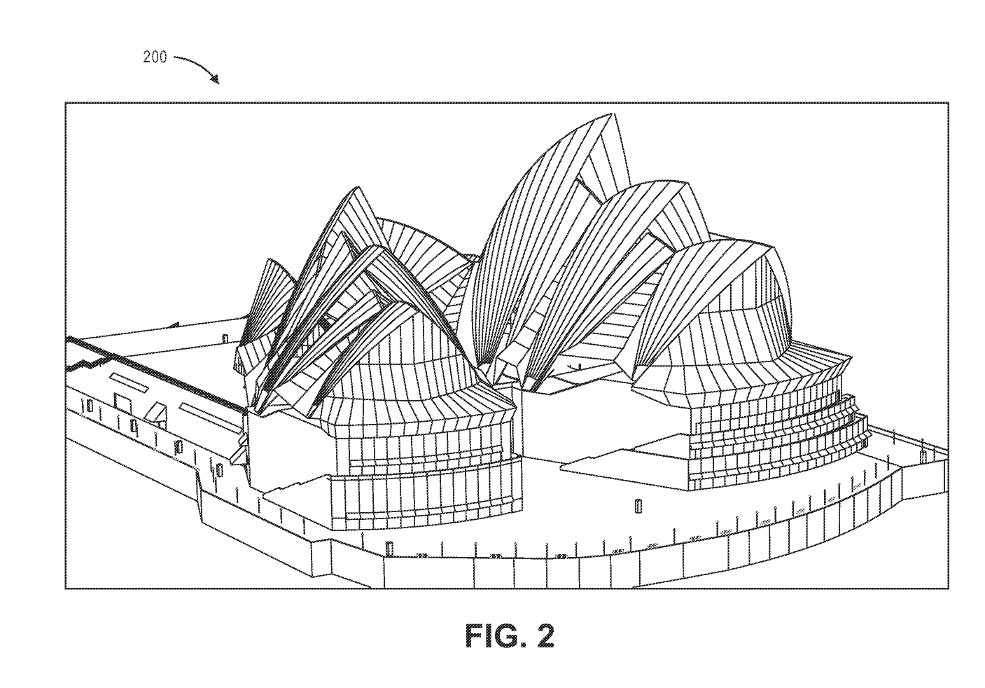

Upon accessing the donee's account, the donee can create a fundraising campaign. To begin, the donee will be required to upload a digital image, such as digital image 200 illustrated in FIG. 2, which will be associated with the fundraising campaign. The digital image may be stored on the servers 102 of the system 100. In some embodiments, the digital image may be related to the fundraising campaign, or the image may have a particular meaning to the donee. For example, as shown in FIG. 2, if the donee is a school that is raising funds for a school trip (e.g., to Sydney, Australia), the donee may upload a digital image of a photograph of the Sydney Opera House. As an alternative example, if the donee is a church that is raising funds for a new worship center, the donee may upload a digital image of an artist's rendering of the to-be-completed worship center.

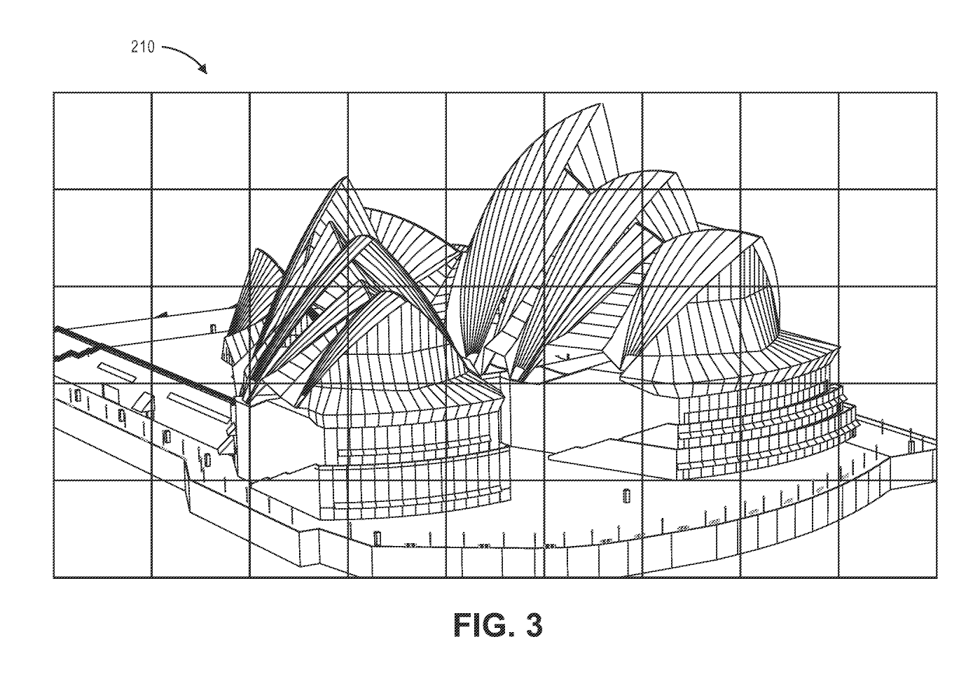

Once the digital image has been uploaded, the donee can provide fundraising data, which may include a total donation amount (e.g., in dollars) that the donee hopes to receive for the fundraising campaign. Additionally, the fundraising data may include a minimum donation amount (i.e., a minimum dollar amount for each donation provided by a donor). The fundraising data may be stored on the servers 102 of the system 100. Based on the total and minimum donation amounts provided by the donee, embodiments of the present invention provide for the uploaded digital image to be partitioned (i.e., divided) into a particular number of tiles, such as shown in partitioned digital image 210 illustrated in FIG. 3. Such partitioning may be performed, for instance, by a processor associated with the server 102 or the computing device 104 of the system 100 of embodiments of the present invention. Of the partitioned digital image, each of the tiles may correspond to a donation that represents the minimum donation amount. For example, if the donee is intending to receive a total donation amount of $1,000, and the donee provides for the minimum donation amount to be $5, then embodiments of the present invention may partition the uploaded digital image into 200 tiles (i.e., $1,000/$5=200). Embodiments provide for the digital image to be partitioned into the number of tiles by various design schemes. For example, the digital image may be partitioned in an array of rectangular sections, comprising a plurality of rows and columns, as is shown in FIG, 3. In the specific case of 200 tiles, the digital image may be broken up into 20 columns and 10 rows, with each tile presented as an intersection of a column and a row. Alternatively, for example, the digital image may be partitioned into 200 puzzle-shaped tiles, which each puzzle-shaped the corresponding to a donation representing the minimum donation amount. However, such illustrations are purely exemplary, as embodiments provide for the digital image to be partitioned into tiles in a plurality of various design schemes.

In other embodiments, the donee may independently select the number tiles and/or the number of rows and columns in which to partition the digital image, For example, once a donee has uploaded a digital image, the donee may specify to partition the digital image up into sixty-thousand tiles (e.g., 200 rows and 300 columns). Remaining with the present example, the donee could provide for the minimum donation amount for each the to be $10. As such, embodiments of the present invention can provide the donee with the total donation amount (Le., $600,000) based on the number of donation units and the minimum donation amount (i.e., 60,000×$10). Alternatively, the donee may provide the number of tiles and/or the number of rows and columns with which to partition the digital image, as well as the total donation amount, such that embodiments of the present invention will provide the donee with the minimum donation amount corresponding to each tile.

Upon uploading the digital image and specifying the fundraising data (Le., the total donation amount and the minimum donation amount), the donee may provide information as to which methods of payment are acceptable to receive donations for the fundraising campaign. In some embodiments, the payments will be facilitated by secure third-party payment service providers. For example, embodiments of the present invention may facilitate electronic payments, such as a provided for through credit/debit cards (e.g., VIA, Mastercard, etc.), electronic funds transfers (e.g., ACH, Wire, etc.), or other online payment platforms (e.g., Paypal, DWOLLA, etc.).

Furthermore, the donee may provide campaign description information that is related to the fundraising campaign. For example, the donee may provide a title to the fundraising campaign. Additionally, the donee may provide a general description of the fundraising campaign, including for what purposes any donations will be used.

Once the donee has provided the above-described information related to the fundraising campaign (i.e., description information, digital image, total donation amount, minimum donation amount, etc.), embodiments of the present invention provide for portions of such information to be displayed on a fundraising webpage (or on a portion of a webpage), with such fundraising webpage being available for review by potential donors. Such information, as described above, may include a title, a description, and/or a digital image related to and/or associated with the fundraising campaign. As such, potential donors can review the information to determine if the fundraising campaign is a matter to which they are interested in making a donation.

In certain embodiments, the information displayed on the fundraising webpage will be hosted by third-party servers that host the donee's website. In such instances, the information may be transferred from the servers 102 of the system 100 of the present invention to the donee's severs for presentation. In other embodiments, the donee's webpage, as hosted by a third-party server, may include a link (e.g., hyperlink) or a web widget (as described in more detail below) configured to obtain and/or configured to provide access to the information so as to display the information via the hyperlink or the web widget. In still other embodiments, the information will be hosted on servers 102 of the system 100 of the present invention, such that the fundraising webpage is stored on and made available by the servers 102 of the system 100 of the present invention.

### Making a Donation to a Fundraising Campaign

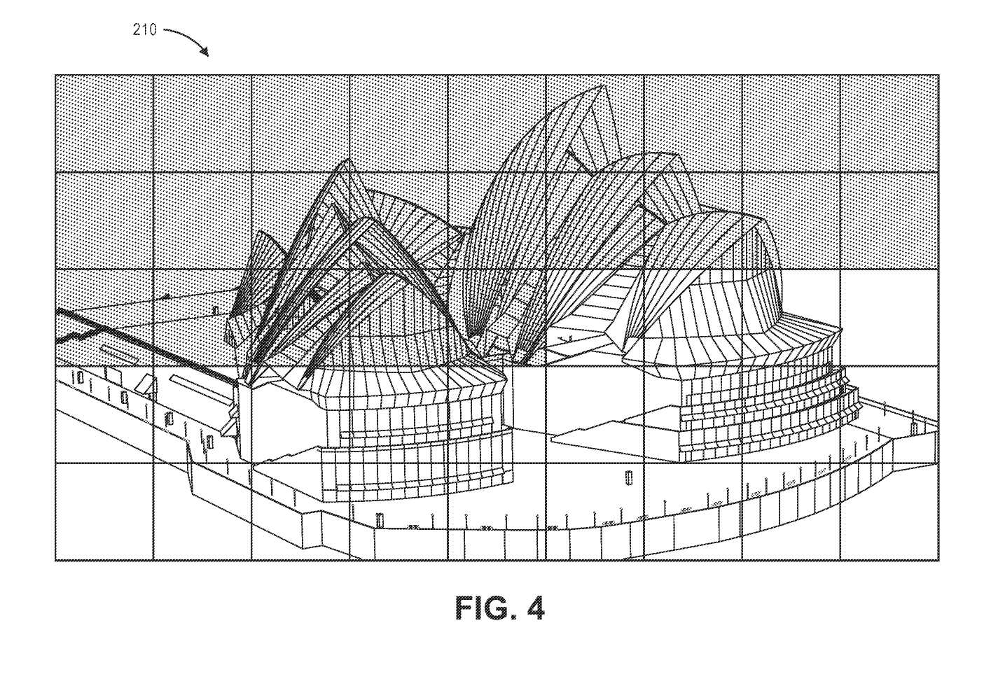

As described above, once the donee has created a fundraising campaign, the information related to the fundraising campaign will be made available on the fundraising webpage (e.g., either on the donee's website or as otherwise made available via the server 102 of embodiments of the present invention). As such, a potential donor is able to make a donation by accessing the fundraising webpage. To begin, the donor may review the fundraising webpage, with such webpage including the fundraising campaign description, donation amounts, a partitioned digital image (See, e.g., partitioned digital image 210 of FIG. 4), and the like, to determine if the fundraising campaign is a matter to which the donor wishes to make a donation. If the donor wishes to make a donation, the donor may choose to make a donation via the fundraising webpage.

In some embodiments, once the donor chooses to make a donation, embodiments of the present invention will provide for the donor to be taken to a donation webpage, or alternatively, for a web widget to be displayed. As used herein, the term “web widget” is defined to mean a stand-alone, independent application configured to be embedded within a website or a mobile app. As with the fundraising webpage, in some embodiment, the donation webpage or web widget may be hosted by the third-party servers that host the donee's website. In other embodiments, the donation webpage or web widget may be hosted by the servers 102 of the system 100 of the present invention.

As with the fundraising webpage, the donation webpage or web widget may be configured to display information related to the donation matter (e.g., description information, digital image, total donation amount, minimum donation amount, etc.). In embodiments in which the donation webpage or web widget is hosted by a third-party server, the donation webpage or web widget may be configured to obtain (e.g., via a request to the server 102) the information and/or may otherwise be configured to provide access to the information, so as to display the information on the donation webpage or the web widget. Alternatively, if the donation webpage or web widget is hosted by the server 102 of the system 100 of the present invention, the donation webpage or web widget may obtain access to the information directly from the server 102. Further ore, if the donation webpage or widget is hosted by the server 102 of the system 100 of the present invention, the donation webpage or widget may be configured to include and/or present certain graphics, images, and textual information associated with the donee, such that the donor understands, or is otherwise given the impression, that the donation webpage or web widget is associated with the fundraising campaign and the donee.

Regardless of whether the donation webpage or web widget is hosted by the donee's servers or the servers 102 of embodiments of the present invention, the donor will be presented, such as via a computing device 104 of the donor, with the digital image that was uploaded by the donee. Specifically, the presented digital image will include the partitioned digital mage, which has been partitioned into the plurality of tiles. Furthermore, embodiments of the present invention provide for the partitioned digital image to be presented such that tiles that have not yet been associated with donations will be at least partially obscured (i.e., shown with “blurred”, “greyed-out” or “partially-filled” colors and/or graphics), while tiles that have previously been associated with donations from prior donors will be unobscured (i.e., shown in “non-blurred”, “solid”, or “filled-in” colors and/or graphics). For instance, as shown in FIG. 4, the tiles on a top portion of the partitioned digital image 210 are partially obscured, while tiles on a bottom portion the partitioned digital image are not obscured. As such, the donor will be able to select a tile that that has not yet been associated with a donation (i.e., an obscured tile) and that the donor would like to associate with a donation. The donor will be able to select a single the if the donor only wishes to donate the minimum donation amount. However, the donor can select to donate more than the minimum donation by selecting multiple, or groups, of tiles with which to associate with the donor's donation. In some embodiments, it may be required that the total amount that can be donated by the donor will be an integer multiple of the minimum donation amount.

Given the above, it should be understood that when the partitioned digital image is presented, a user can instantaneously see how much of the total donation amount the donee has thus far received. For instance, a digital image with all of the tiles obscured will not have received any donations, while a digital image with all of the tiles unobscured will have received enough donations to meet the total donation amount. With reference to the partitioned digital image 210 of FIG. 4, the digital image 210 has about half of its tiles unobscured, which indicates that the donee has received donations that satisfy about half of its total donation amount.

After the donor has selected one or more tiles from the partitioned digital image to associate with a donation, the donor will be provided with a payment portal through which the donor can provide the donation. The payment portal may include the electronic payment options (as provided by the third-party payment processing services) that were previously selected by the donee as being applicable to the fundraising campaign. Additionally, in some embodiments, the payment will be performed through a secure communications protocol, such as https. Thus, through the payment portal, the donor will be able to make a secure payment for the donor's intended donation.

In addition to making a monetary donation, embodiments of the present invention provide for donors to create a memorial that will be associated with the donation. In particular, the memorial will be associated with the one or more tiles that the donor selected to be associated with the donation. In some embodiments, the memorial will comprise memorial information that includes (1) an individual or entity to whom the donation is dedicated, (2) one or more personal messages, and (3) the person or entity that made the donation. As will be described in more detail below, the memorial information will be configured to be presented along with the partitioned digital image.

As previously mentioned, some embodiments will require the donor to create a donor account before making a donation to a fundraising campaign. In such instances, embodiments of the present invention provide for the identification information associated with the donor's account (e.g., name, address, etc.) to be used to generate a donation receipt that may be used by the donor to make a deduction on the donor's taxes. Such a receipt may be presented graphically, such that the donor can print the receipt for future use. In embodiments in which the donor is not required to establish an account, the donor may nonetheless be requested to provide certain identification information for purposes of generating the receipt. In even further embodiments, the identification information, whether provided during creation of the donor account or otherwise, may be stored in the server 102 for future access and use. For example, the identification information may be used so that the donee can later contact the donor to give updates on the fundraising campaign, to request additional donations, for reporting purposes (e.g., IRS reporting), or for other non-related marketing purposes.

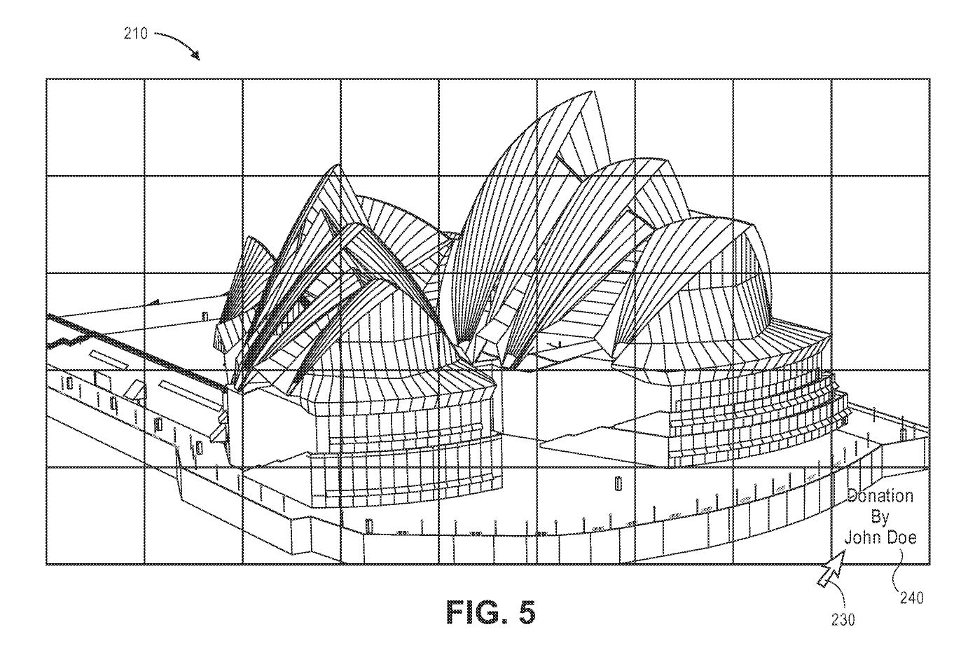

Embodiments of the present invention provide for the fundraising webpage to present current status information related to the fundraising campaign. For example, as shown in FIGS. 4-5, the donee's fundraising webpage may be configured to present the partitioned digital image 210, which is divided into its particular number of tiles. With reference to FIG. 4, those tiles that have been associated with a donation by a donor will be shown unobscured, indicating that the tiles have been associated with a donation. The remaining donation units that have yet to be associated with a donation are shown at least partially obscured. Thus, with just a cursory view of the partitioned digital image 210, an observer can determine how much of the fundraising campaign's total donation amount has been met. Additionally, the donation webpage may list various statistical information related to the fundraising campaign, such as: the total monetary donations received, the average monetary donation, the number of donors, etc. Such statistical information may also be provided to the donee via the donee's account or, alternatively, via email, text message, or the like. Once the total donation amount has been met, each of the tiles of the partitioned digital image 210 will be unobscured, as shown in FIG. 5.

In addition, embodiments of the present invention provide for the fundraising website to present the memorial information that was entered by specific donors and that corresponds to specific donations. Such memorial information may be presented to an observer when the observer highlights or selects specific donation units that are associated with specific donations and specific memorial information, For instance, as shown in FIG. 5, when a user highlights a particular tile (e.g., via GUI pointer 230), embodiments will display the memorial information 240, which in the example illustrated in FIG. 5 includes the person and/or entity who made the donation.

In further embodiments, the fundraising webpage may include a search function that allows a user to search for various keywords or phrases that may be included in specific memorial information. As such, for example, a user looking for a particular tile that was dedicated to a particular individual, can enter the individual's name into the search function, and the particular tile (along with the memorial information) will be highlighted for the user to observe.

Furthermore, once a donor has provided a donation, embodiments of the present invention may provide an option for the donor to export information related to the fundraising campaign and/or the donor's donation via social networks. Such social networks may include, for instance, Facebook, Twitter, Google+, Instagram, Pintrest, or the like. For example, once a donor has made a donation, embodiments of the present invention may provide an option for the donor to post (to one of the donor's social networks) the digital image of the fundraising campaign, the title and/or description of the fundraising campaign, the memorial information provided by the donor, the donation amount, or any other similar information that is related to the fundraising campaign. As such, donor's social network will be a form of advertising for the fundraising campaign. Furthermore, the donor's social network post may include a hyperlink operable to direct observers to the donee's fundraising webpage. As such, observers can be directed to the fundraising webpage to make their own donations.

Such an interactive computer program, system, and method of interactive fundraising will provide an incentive for donors to make more frequent and higher value donations. Furthermore, by allowing observers to view the current status and the memorial information associated with each fundraising campaign, such observers will be incentivized to make their own donations.

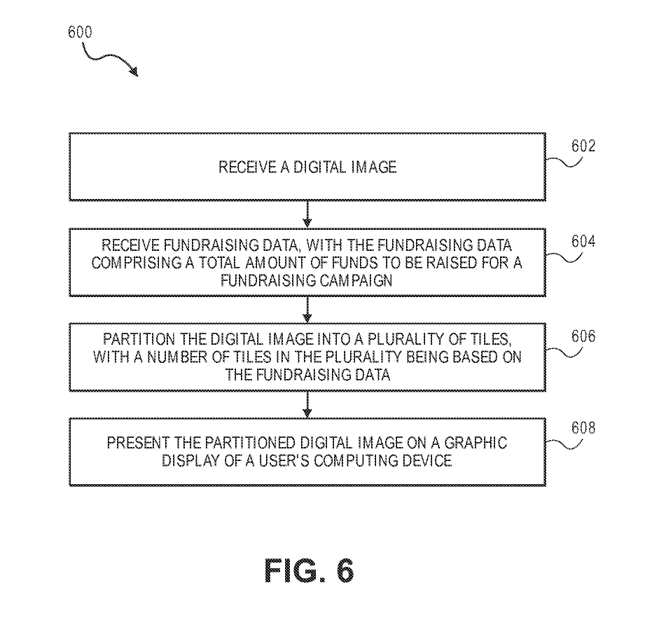

Given the above description, embodiments of the present invention include a method 600, as illustrated in FIG. 6, for facilitating interactive fundraising. The method 600 includes the initial Step 602 of receiving a digital image. An addition Step 604 includes receiving fundraising data, with the fundraising data comprising a total amount of funds to be raised for a fundraising campaign. An additional Step 606 includes partitioning the digital image into a plurality of tiles, with a number of tiles in the plurality being based on the fundraising data. A further Step 608 includes presenting the partitioned digital image on a graphic display of a user's computing device.

Embodiments of the present additionally include a method 700 for facilitating interactive fundraising. An initial Step 702 of the method 700 includes receiving a digital image and storing the digital image on the database. An additional Step 704 includes receiving fundraising data and storing the fundraising data in the database, with the fundraising data comprising a total amount of funds to be raised. An additional Step 706 includes partitioning the digital image into a plurality of tiles, with a number of tiles in the plurality being based on the fundraising data. A next Step 708 includes receiving a request from an independent application to provide access to the partitioned digital image. A next Step 710 includes providing the independent application with access to the partitioned digital image, with each of the tiles in the partitioned digital image being obscured. A next Step 712 includes receiving, from the independent application, information indicative of a donation being made. A further Step 714 includes providing the independent application with access to the partitioned digital image, with one or more tiles in the partitioned digital image being unobscured.

Although the invention has been described with reference to the exemplary embodiments illustrated in the attached drawings, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable storage medium with a computer program for facilitating interactive fundraising stored thereon, wherein the computer program instructs a processor to perform the following steps:
receive a digital image;
receive fundraising data, wherein the fundraising data comprises a total amount of funds to be raised for a fundraising campaign;
partition the digital image into a plurality of toes, wherein a number of tiles in the plurality is based on the fundraising data; and
present via a graphic display associated with a user's computing device the partitioned digital image.

2. The computer readable medium of claim 1, wherein the fundraising data further comprises a minimum donation amount, and wherein the number of tiles in the partitioned digital image is determined by dividing the total amount of funds to be raised by the minimum donation amount.

3. The computer readable medium of claim 1, wherein the plurality of tiles comprises an array of rectangular sections.

4. The computer readable medium of claim 1, wherein the plurality of tiles in the partitioned digital image is at least partially obscured.

5. The computer readable medium of claim 4, wherein the computer program further instructs the processor to perform the additional steps of:
receive information indicative of a donation being made;
present via the graphic display associated with the user's computing device the partitioned digital image, wherein one or more tiles in the partitioned digital image are unobscured.

6. The computer readable medium of claim 5, wherein a number of unobscured tiles is determined based on a value of the donation made.

7. The computer readable medium of claim 5, wherein upon receiving information indicative of enough donations being made to satisfy the total amount of funds to be raised, the computer program further instructs the processor to present via the graphic display associated with the user's computing device the partitioned digital image, wherein each of the tiles in the partitioned digital image are unobscured.

8. The computer readable medium of claim 5, wherein the computer program further instructs the processor to perform the additional steps of:
receive memorial information associated with the information indicative of a donation being made;
wherein at least a portion of the memorial information is presented on the graphic display associated with the user's computing device along with the one or more unobscured tiles in the presented partitioned digital image.

9. The computer readable medium of claim 8, wherein the memorial information is only presented when a user highlights the one or more unobscured tiles in the presented partitioned digital image via a user control interface of the user's computing device.

10. A method for facilitating interactive fundraising comprising the following steps;
receiving a digital image;
storing the digital image in a database;
receiving fundraising data, wherein the fundraising data comprises a total amount of funds to be raised for a fundraising campaign;
partitioning, via a processor, the digital image into a plurality of tiles, wherein a number of tiles in the plurality is based on the fundraising data; and
presenting on a graphic display the partitioned digital image.

11. The method of claim 10, wherein the fundraising data further comprises a minimum donation amount, and wherein the number of tiles in the partitioned digital image is determined by dividing the total amount of funds to be raised by the minimum donation amount.

12. The method of claim 10, wherein the plurality of tiles comprises an array of rectangular sections.

13. The method of claim 10, wherein the plurality of tiles in the partitioned digital image is at least partially obscured.

14. The method of claim 13, comprising the additional steps of:
receiving information indicative of a donation being made;
presenting on the graphic display associated with the user's computing device the partitioned digital image, wherein one or more toes in the partitioned digital image are unobscured.

15. The method of claim 14, wherein the number of unobscured tiles is determined based on a value of the donation made.

16. The method of claim 14, comprising the additional steps of:
receiving memorial information associated with the information indicative of a donation being made;
wherein at least a portion of the memorial information is presented on the graphic display associated with the user's computing device along with the one or more unobscured tiles in the presented partitioned digital image.

17. A system for facilitating interactive fundraising, said system comprising:
a processor;
a database; and
a non-transitory computer readable storage medium with a computer program stored thereon stored thereon, wherein the computer program instructs the processor to perform the following steps:
receive a digital image and store the digital image on said database;
receive fundraising data and store said fundraising data on said database, wherein the fundraising data comprises a total amount of funds to be raised for a fundraising campaign;
partition the digital image into a plurality of tiles, wherein a number of tiles in the plurality is based on the fundraising data;
receive a request from a third-party application to provide access to the partitioned digital image;
provide the independent application with access to the partitioned digital image, wherein each of the tiles in the partitioned digital image are obscured;
receive, from the third-party application, information indicative of a donation being made; and
provide the independent application with access to the partitioned digital image, wherein one or more tiles in the partitioned digital image are unobscured.

18. The system of claim 17, wherein the fundraising data further comprises a minimum donation amount, and wherein a number of tiles in the partitioned image is determined by dividing the total amount of funds to be raised by the minimum donation amount.

19. The system of claim 17, wherein a number of unobscured tiles is determined based on a v e of the donation made.

20. The system of claim 17, wherein the independent application is a web widget.
